(19) United States
(12) Patent Application Publication
(10) Pub. No.: US 2015/0227599 A1
(43) Pub. Date: Aug. 13, 2015

(54) MANAGEMENT DEVICE, MANAGEMENT METHOD, AND RECORDING MEDIUM FOR STORING PROGRAM

(71) Applicant: HITACHI, LTD., Tokyo (JP)

(72) Inventors: Kazuhito Yokoi, Tokyo (JP); Shoji Kodama, Tokyo (JP); Yohsuke Ishii, Tokyo (JP)

(73) Assignee: HITACHI, LTD., Tokyo (JP)

(21) Appl. No.: 14/426,171

(22) PCT Filed: Nov. 30, 2012
(86) PCT No.: PCT/JP2012/081022

§ 371 Date: Mar. 5, 2015

(51) Int. Cl. G06F 17/30

(52) U.S. Cl. CPC G06F 17/30575; G06F 17/30371; G06F 17/30864; G06F 17/30563

(57) ABSTRACT

Replication is performed with consideration of data integrity between each subsystem when replication of a computer system that uses data by processing data and transferring the data to a next subsystem is performed. A management device that manages a computer system including a second subsystem which performs a predetermined process for data processed by a first subsystem and generates data which is a target of data processing by a third subsystem obtains process history information in which information indicating an input source and an output destination subsystem of data that is processed by each subsystem is included and trigger information in which information indicating a trigger for data input and output of the input source and the output destination subsystems is included, thereafter detects a dependence relationship of data input and output between each subsystem from the process history information, calculates a replication trigger for subsystems subsequent to a next subsystem for each of the subsystems subsequent to the next subsystem that is next to a subsystem of which an input source is not present with reference to the trigger information, and generates, in response to the replication trigger, a replication of each subsystem in another different computer system.

### TECHNICAL FIELD

The present invention relates to a management device that manages the integrity of data between subsystems at the time of replication of each subsystem in a computer system which performs data transfer between each subsystem, a management method, and a recording medium for storing a program.

### BACKGROUND ART

There is known in the related art a technology that is intended for redundancy, expansion, and the like of a system by replicating the configuration of a computer as image data and creating a new computer system. In PTL 1, for example, there is disclosed a technology that can recover a system by creating a snapshot of a server periodically or at a specified time and building a new server from the snapshot when a failure occurs in the server.

A recent large-scale computer system that realizes a cloud environment, big data processing, and the like tends to have a larger and complicated system configuration. Not only the number of physical computers constituting a system simply increases but also a virtualization technology is developed, and a computer system that is configured by servers (includes a virtual server and may be configured as a subsystem) performing a specific process and outputs one process result through cooperation between the servers is realized. Thus, the complexity of a system configuration continues to be increased.

An example of such a system performing a process through cooperation is a computer system that manages structured, semi-structured, and unstructured data having different data formats, deduces a relationship between those types of data dynamically, and outputs the data as a result of response to a request from a client and the like.

The system may be configured by extract/transform/load (ETL) that collects a predetermined piece of data from a data source, which stores various types of data as described above, and generates post-process data by performing conversion and the like for the predetermined piece of data into a predetermined data format, a data warehouse (DWH) that generates post-process data which serves as a basis for searching, analyzing, or the like of a relevance and the like between pieces of post-process data that the ETL generates, an interpretation functional unit such as a search server and an analysis server that searches or analyzes post-process data stored in the DWH and generates post-process data as a search or analysis result, and the like. Data that is collected from the data source by the ETL is transferred (crawling and the like) from the ETL to the DWH in response to a predetermined trigger (for example, at a predetermined time) and thereafter, is transferred (crawling and the like) from the DWH to the search server or the analysis server. In addition, to reflect an update occurring in the data source on each functional server (functional unit), data transfer is sequentially repeated from the data source to the search server and the analysis server in response to a predetermined trigger (for example, at a predetermined time interval). That is to say, the integrity of data that each functional server (unit) retains is secured at the point in time when transfer of crawled data from the data source to the search server and the analysis server ends.

### CITATION LIST

### Patent Literature

PTL 1: JP-A-2011-60055

### SUMMARY OF INVENTION

### Technical Problem

Incidentally, there are various objects that a replication technology for a single computer as disclosed in PTL 1 may not realize in a case of creating a replication of a computer system that is configured as described above.

The integrity of data retained in each functional server (unit) may be broken when data is being transferred from the data source via each functional server (unit). For example, when the data source is updated, and data crawling is performed between the DWH and the ETL, both of which collect the post-update data, data that is retained in the search server or in the analysis server at the point in time of the update and crawling is data prior to the post-update data that is crawled in the ETL and in the DWH (that is, the search server or the analysis server retains data prior to reflection of a policy of the data source).

When replication of the computer system is performed by using the technology in PTL 1 at such a timing, each functional server (unit) of the replicated system retains data that does not have integrity. That is to say, when operation of the replicated system starts, this causes a problem that integrity of data has to be achieved first between each functional server in the replicated system.

The purpose of the replicated system is not only to simply build a reserve system but also to be used as a system for switching at the time of occurrence of failure of a current system or as a scale-out system for system expansion to cope with an increased load on the current system. Achieving integrity of data before the start of operation in the replicated system is a great object in terms of immediate operation along with losing convenience of use.

The replicated system is also generally used for the purpose of testing processing operation. However, even in a case of performing a processing test, it is difficult to verify the test result when the integrity of data that each functional server (unit) retains is not assured. Particularly, as the computer system processes a greater amount of data, a process for assuring integrity of data requires a corresponding time. Thus, there is also a problem of losing convenience of use.

As in those examples, in a case of performing replication of a computer system in which data is processed and is transferred to a next functional server (subsystem) to be used, it is necessary to manage a replication trigger with consideration of the integrity of data between each functional server (subsystem).

### Solution to Problem

According to the invention disclosed in claim 1, there is provided a management device that manages a computer system including a second subsystem which performs a predetermined process for data processed by a first subsystem and generates data which is a target of data processing by a third subsystem, in which the management device obtains process history information in which information indicating an input source subsystem and an output destination subsystem of data that is processed by each of the first, the second, and the third subsystems is included and trigger information in which information indicating a trigger for data input and output of the input source and the output destination subsystems is included, detects a dependence relationship of data input and output between the first, the second, and the third subsystems from the process history information, calculates, on the basis of the dependence relationship, a replication trigger for subsystems subsequent to a next subsystem for each of the subsystems subsequent to the next subsystem that is next to a subsystem of which an input source is not present with reference to the trigger information, and generates, in response to the replication trigger, a replication of each of the subsystems subsequent to the next subsystem in another computer system that is different from the computer system.

### Advantageous Effects of Invention

According to an aspect of the present invention, a replication trigger in which data integrity is assured between each subsystem (functional unit) where data is transferred can be determined.

Another object or effect of the present invention is more apparent from the following description of embodiments.

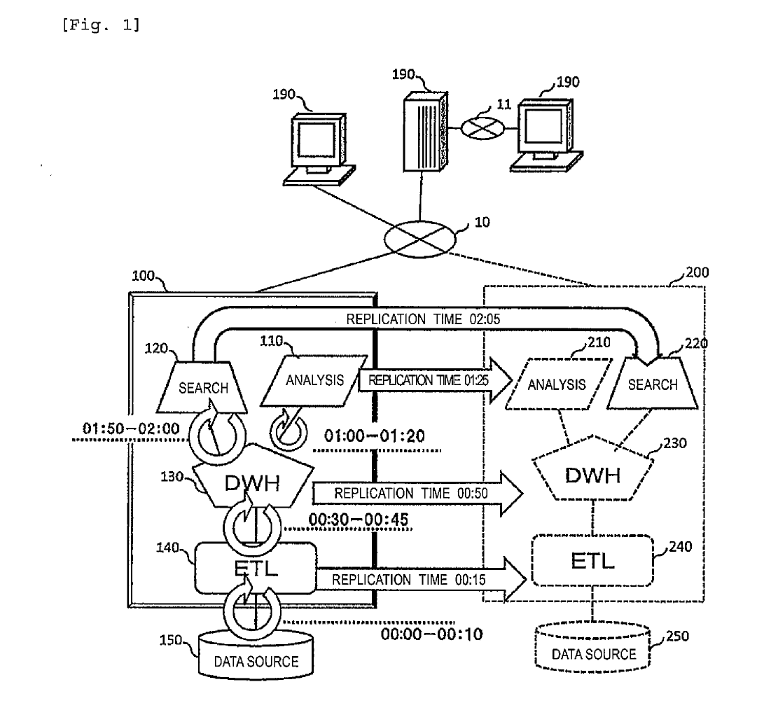

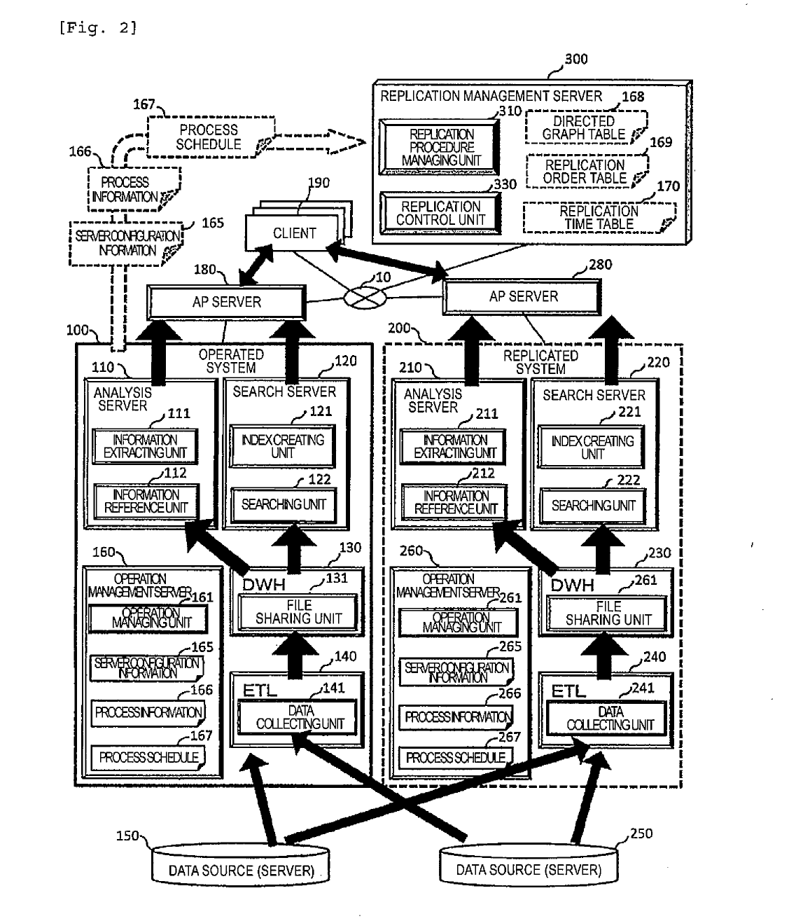

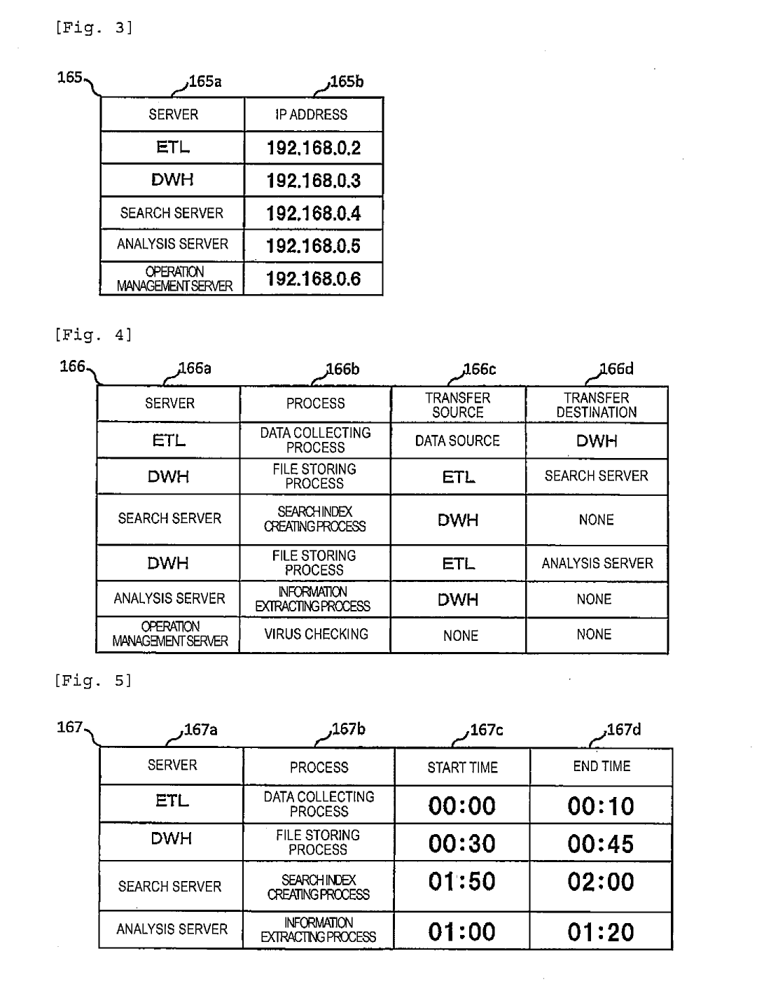

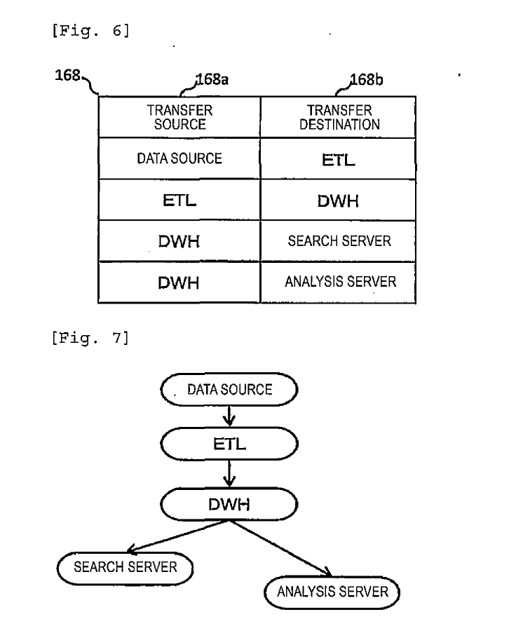

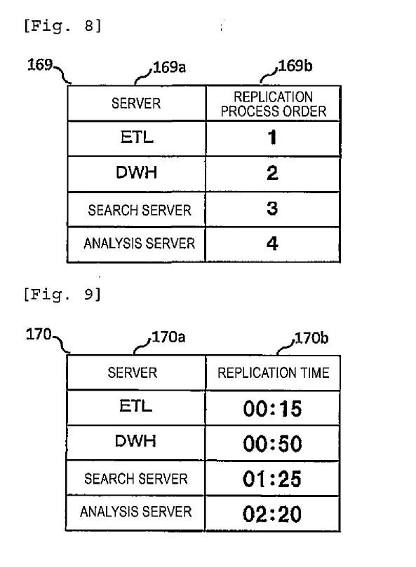

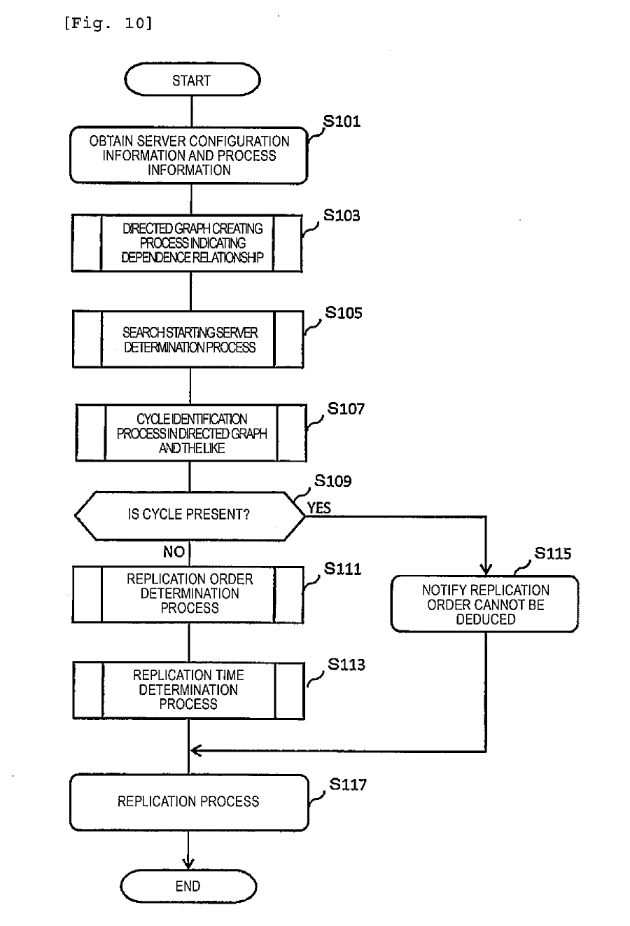

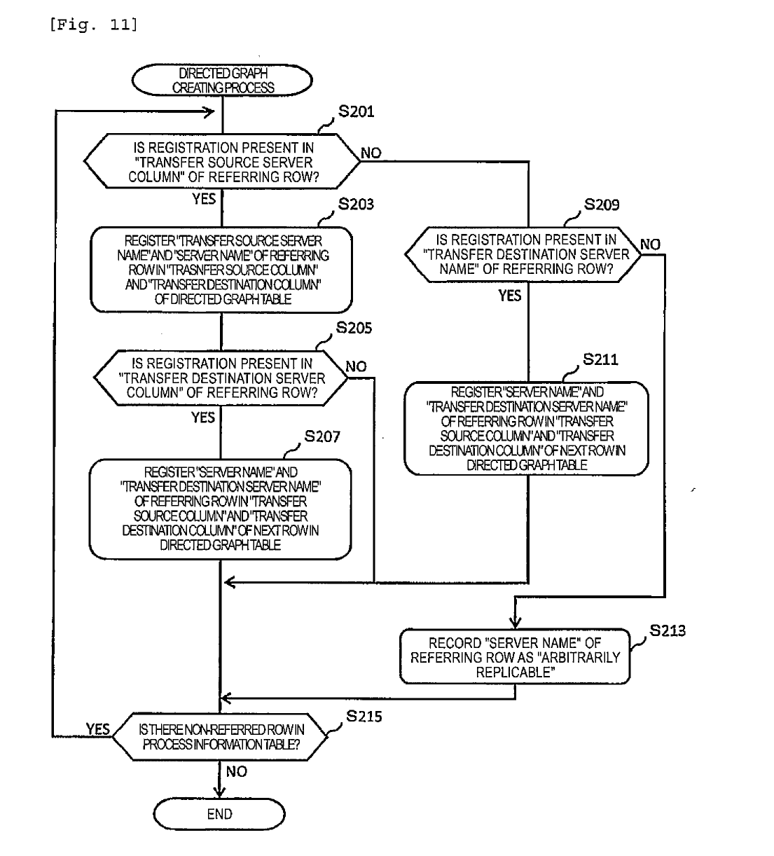

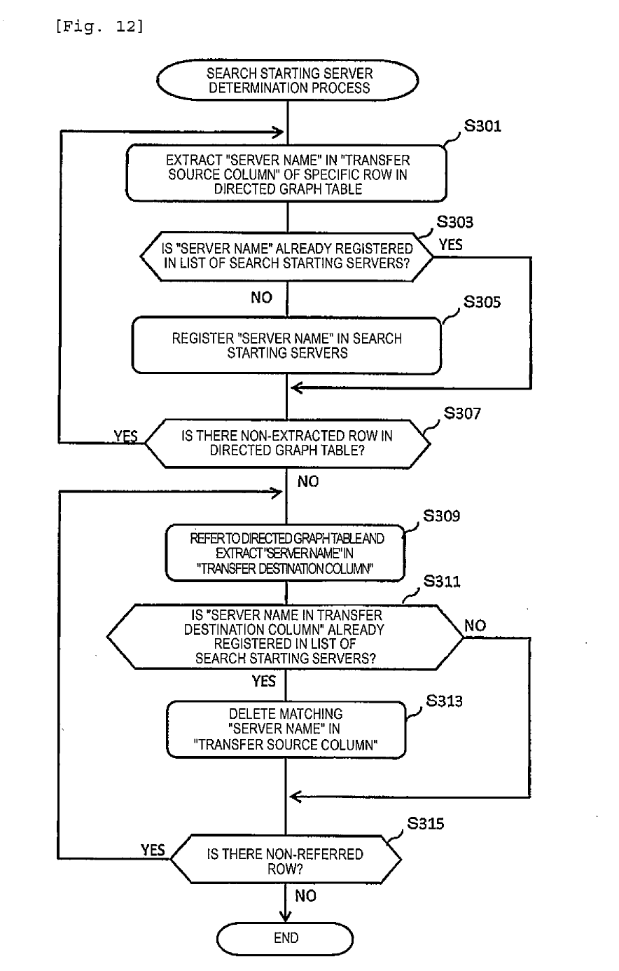

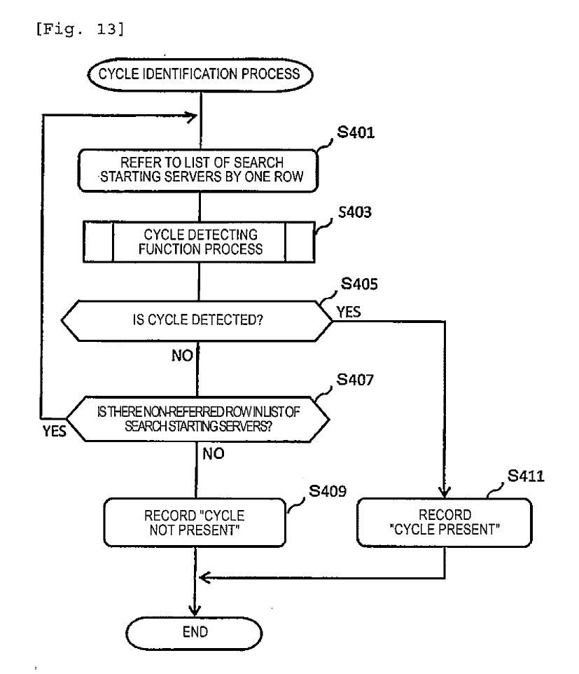

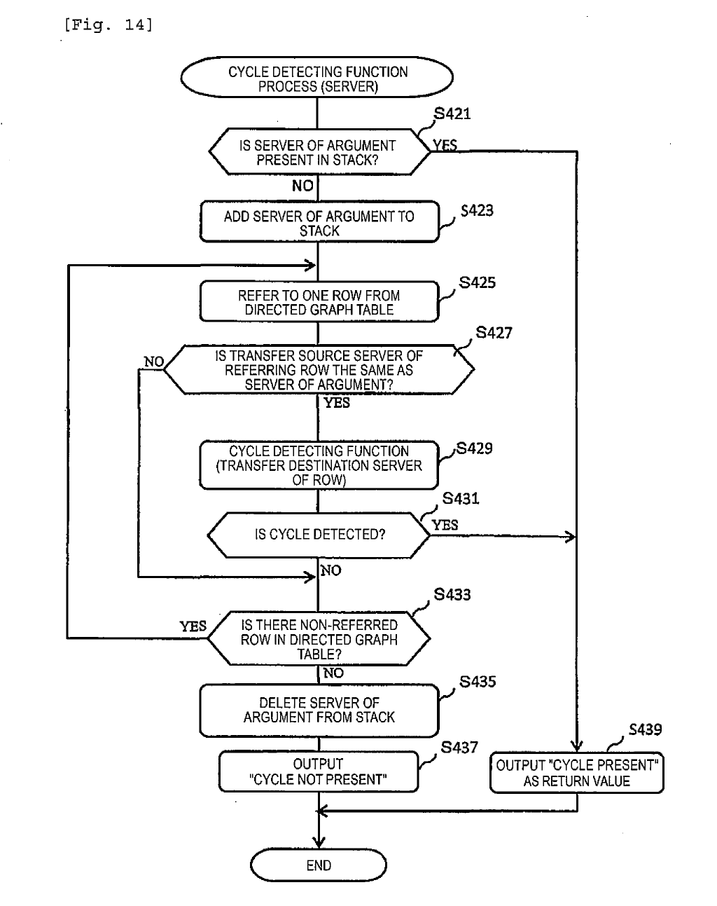

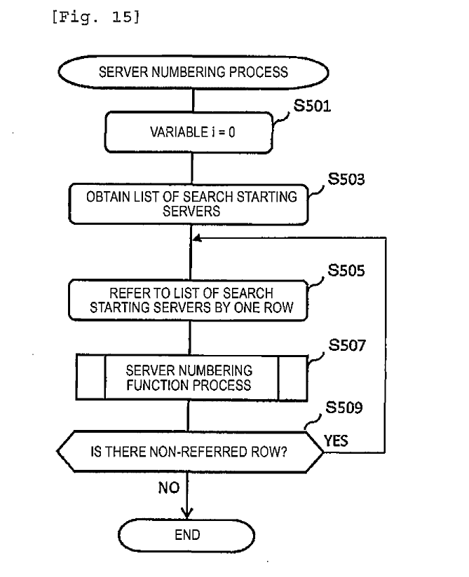

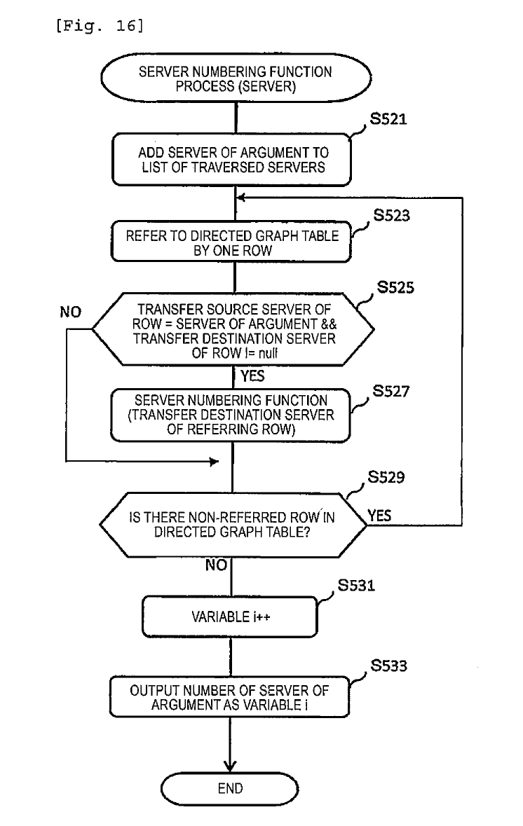

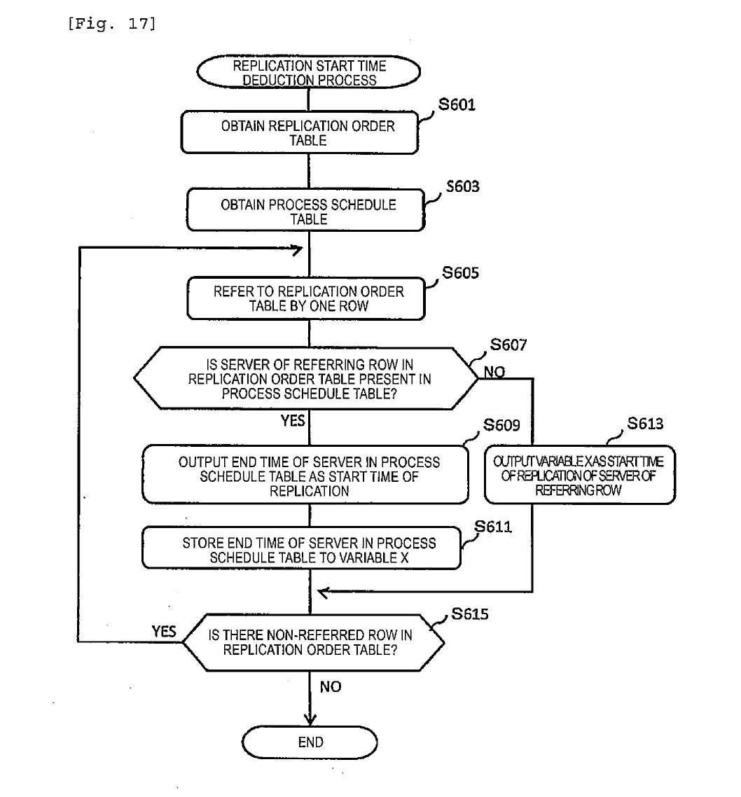

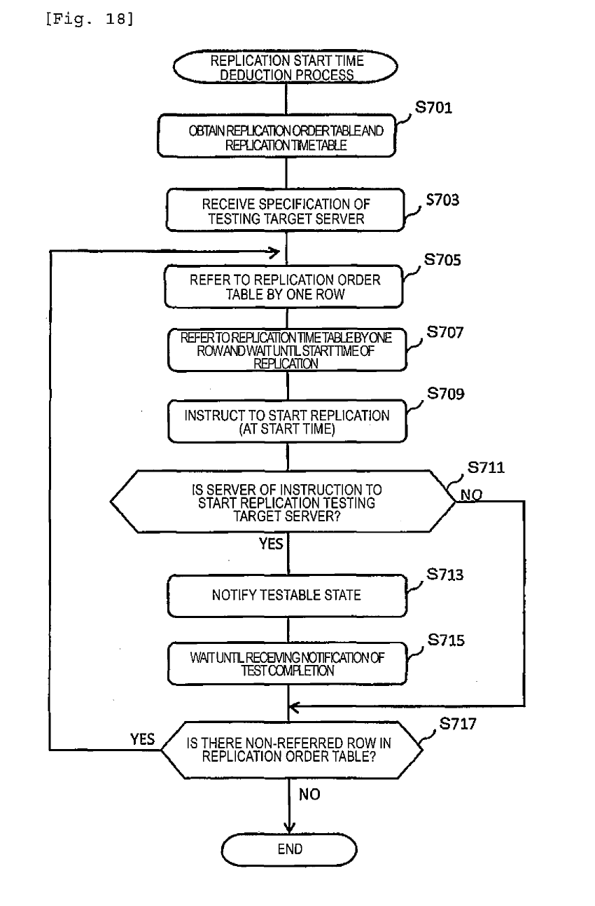

### BRIEF DESCRIPTION OF DRAWINGS

[FIG. 1] FIG. 1 is a schematic diagram illustrating the outline of a computer system of a first embodiment to which the present invention is applied.

[FIG. 2] FIG. 2 is a block diagram illustrating an example of the configuration of the computer system in the present embodiment.

[FIG. 3] FIG. 3 is a schematic diagram illustrating an example of server configuration information in the present embodiment.

[FIG. 4] FIG. 4 is a schematic diagram illustrating an example of process information in the present embodiment.

[FIG. 5] FIG. 5 is a schematic diagram illustrating process schedule information in the present embodiment.

[FIG. 6] FIG. 6 is a schematic diagram illustrating an example of a directed graph table in the present embodiment.

[FIG. 7] FIG. 7 is a conceptual diagram illustrating the order of data transfer (crawling and the like) in the computer system in the present embodiment.

[FIG. 8] FIG. 8 is a schematic diagram illustrating an example of a replication order table in the present embodiment.

[FIG. 9] FIG. 9 is a schematic diagram illustrating an example of a replication time table in the present embodiment.

[FIG. 10] FIG. 10 is a flowchart illustrating an example of overall processing of a replication procedure for a server in the present embodiment.

[FIG. 11] FIG. 11 is a flowchart illustrating an example of a process of creating the directed graph table in the present embodiment.

[FIG. 12] FIG. 12 is a flowchart illustrating an example of a process of determining a search starting server in the present embodiment.

[FIG. 13] FIG. 13 is a flowchart illustrating an example of a process of identifying presence or absence of a cycle in the directed graph table in the present embodiment.

[FIG. 14] FIG. 14 is a flowchart illustrating an example of use of a recursive function in the process of identifying presence or absence of a cycle illustrated in FIG. 13.

[FIG. 15] FIG. 15 is a flowchart illustrating an example of a process of deducing the order of replication of servers in the present embodiment.

[FIG. 16] FIG. 16 is a flowchart illustrating an example of use of a server number association function in the process of deducing the order of replication of servers illustrated in FIG. 15.

[FIG. 17] FIG. 17 is a flowchart illustrating an example of a process of deducing a time of a replication process in the present embodiment.

[FIG. 18] FIG. 18 is a flowchart illustrating overall processing of a computer system of a second embodiment to which the present invention is applied.

### DESCRIPTION OF EMBODIMENTS

### [First Embodiment]

Hereinafter, embodiments of the invention will be described by using the drawings. First, the outline of the present embodiment will be described.

FIG. 1 schematically illustrates the outline of a computer system 1 to which the present invention is applied.

The computer system 1 includes a first system 100 and a second system 200 that is a replication of the first system 100. A network 10 is connected to the first system 100 in a wired or wireless manner, and the first system 100 is communicably connected to a group of clients 190. The first system 100 responds with a process result to various requests that are transmitted from the client 190. In addition, the network 10 is also connected to the second system 200. The second system 200 communicates with the group of clients 190 when being currently operated and performs various processes.

The first system 100 includes various subsystems. A subsystem means a functional unit for performing a specific process. For example, a subsystem is a unit of building a predetermined application, middleware, or an OS physically or logically (for example, a virtual system) and performing a predetermined output with respect to a predetermined input. The present embodiment includes functional servers such as an analysis server 110, a search server 120, a DWH 130, and an ETL 140 as an example of the subsystem. Each functional server may be called a subsystem hereinafter.

Data that is stored on a data source 150 (included as the subsystem) outside the system is crawled by the ELT 140 in response to a predetermined trigger (at a predetermined time in the present example), next crawled by the DWH 130 at a predetermined time, crawled by each of the analysis server 110 and the search server 120 thereafter at a predetermined time, and is transferred. A searching and/or an analyzing process is performed in the analysis server 110 and/or the search server 120 in response to a request from the group of clients 190, and the process result is responded.

In each functional server, data format conversion or various processes are performed for data that is obtained from a functional server which is early in the order of data transfer, and post-process data is generated. The generated post-process data is transferred as a processing target in a next functional server. For example, data that the ETL 140 collects is text data, image data, and metadata thereof, and these types of data are processed into a predetermined data format. The processed data is processed into a predetermined saving format and is saved in the DWH 130. The analysis server 110 or the search server 120 crawls the data that is saved in the DWH 130, performs processes such as extracting and analyzing a predetermined piece of analysis target data or creating an index, and uses the processed data in response to a request from the client 190 through an AP server 180.

The second system 200 is a replication of the first system 100. Replication can be performed after reflection of data that each functional server of the first system 100 retains is completed.

In the same drawing, first, crawling (indicated by a circular arrow) is started by the ETL 150 from the data source 150 at a time “00:00” and is completed at “00:10”. Thereafter, at “00:15” , the ETL 140 is replicated as an ETL 240 in the second system.

Similarly, at “00:30”, crawling of data for which the ETL 140 finishes crawling at “00:10” is started by the DWH 130. At “00:45”, the crawling and generation of post-process data is completed. Thereafter, at “00:50”, the DWH 130 is replicated as a DWH 230.

In the analysis server 120, crawling is performed for the same data of the DWH 130 during “01:00-01:20”, and thereafter, the analysis server 120 is replicated in the second system 200 at “01:25”.

In the search server 120, crawling is performed from the DWH 130 during “01:50-2:00”, and the search server 120 is replicated as a search server 220 in the second system 200 at “02:05”.

The crawling process of the functional servers may be performed multiple times for the same data. For example, in FIG. 1, the analysis server 110 can be set to perform the first crawling process during “01:00-01:20” and then perform the second crawling process during “01:40-01:50”. The ETL 140 may crawl the result of the first analyzing process of the analysis server 110, and the analysis server 110 may perform analysis again with the crawled data. As such, when a cycle of performing the crawling process is present during data transfer, the integrity of data between all of the functional servers cannot be assured. When such a cycle is present, a replication of the analysis server 110 is generated under the condition that integrity is not assured for the analysis server 110. A process for searching a cycle and a replication process in a case of presence of a cycle will be described later.

As described above, each subsystem constituting the computer system 1 is configured in a manner in which a replication of each subsystem is generated along the order of data transfer after crawling and the like of data by other subsystems are ended. Thus, there can be generated a replicated system (the second system 200) that retains data of which the integrity is assured between subsystems.

A process of assuring the integrity of data between each subsystem in the second system 200 at the start of use of the second system 200 is not necessary when the second system 200 is used as a standby system, when the second system 200 is used as an expansion system, or when the second system 200 is used as a test system, and operation of the second system 200 can be started early.

Above is the outline of the computer system 1.

Hereinafter, the computer system 1 will be described in detail.

The configuration of the computer system 1 is illustrated in detail in FIG. 2. In the computer system 1, the first system 100 and one or a plurality of clients 180 are connected through the network 10. An application server (referred to as an “AP server” hereinafter) 190 that controls sessions or processes is configured to be disposed between the first system 100 and the client 180.

The AP server 190 includes a function of a Web server and enables the computer system 1 to be applied to a service oriented architecture (SOA) environment. For example, the AP server 190 communicates with the analysis server 110 and the search server 120 with an SOAP message in response to a request from the client 180 and transmits a result to the client 180.

Data sources 150 and 250 are versatile server apparatuses disposed outside the first system and are configured by one or a plurality of physical computers or storage devices. The data sources 150 and 250 store data such as structured data, semi-structured data, unstructured data, and the like that are used by various external systems (not illustrated) to which the data source is connected in storage devices such as a HDD, a solid state drive (SSD), and the like.

The first system 100 includes the analysis server 110, the search server 120, the DWH 130, and the ETL 140 as functional servers and also includes an operation management server 160 that performs management thereof. In the present embodiment, a description will be provided for an example of applying versatile server apparatuses having CPUs, memories, and auxiliary storage devices to these servers. However, the present invention is not limited to this example. A part or all of each functional server may be provided as a virtual server on the same physical computer.

An information extracting unit 111 and an information reference unit 112 are realized through cooperation between a program and a CPU in the analysis server 110. The analysis server 110 is a server that reads data from the DWH 130 along a schedule, retains information obtained by analyzing the content of data as metadata, and enables reference of the information. Specifically, the content of image data is analyzed by the information extracting unit 111, and information such as the name of an object included in an image is generated as a metafile. The information reference unit 112 can refer to the generated metafile in response to a metafile reference request from the client 180.

An index creating unit 121 and a searching unit 122 are realized through cooperation between a program and a CPU in the search server 120. In response to a data search request from the client 180, the search server 120 transmits the location (path and the like) of data that matches a keyword included in the request. Specifically, the index creating unit 121 creates an index for data of the DWH 130 along a schedule. The searching unit 122 receives a data search request from the client 180, refers to the generated index, and transmits the location (path and the like) of data that includes a keyword as a response result.

The DWH 130 is a file server. In the DWH 130, data is crawled from the ETL 140 along a schedule and is stored in a file format. In the DWH 130, a CPU and a program realize a file sharing unit 131 that provides a file sharing function to the analysis server 110 or the search server 120, and this enables access to the stored file.

The ELT 140 collects data (crawling) along a schedule from the data source 150 that is outside the first system 100. Data collected from the data source 150 is output to the DWH 130 along a predetermined schedule.

The operation management server 160 is a server that receives a change of configuration information or a change of process setting for each functional server of the first system from a management terminal (not illustrated) of a system administrator and performs a changing process. The operation management server 160 further has a function of communicating with a replication management server 300 that will be described later and providing configuration information, a process status, and a process schedule of the first system.

An operation managing unit 161 is realized through cooperation between a CPU and a program in the operation management server 160. The operation managing unit 161 is a functional unit that records configuration information input from the management terminal and sets the configuration of each functional server on the basis of the configuration information. A storage unit (not illustrated) of the operation management server 160 retains server configuration information 165 in which configuration information for each functional server of the first system 100 is recorded, process information 166, and a process schedule 167.

An example of the server configuration information 165 is schematically illustrated in FIG. 3. The server configuration information 165 is configured by a server column 165a that retains an ID (name) of each functional server constituting the first system and an IP address column 165b that retains an IP address of each functional server. These columns are associated with each other to be managed. When values are retained in both of the server column 165a and the IP address column 165b, this means the corresponding functional server is present in the first system 100.

An example of the process information 166 is schematically illustrated in FIG. 4. The process information 166 is configured by a process column 166b that retains the content of a process that each functional server performs, a transfer source server column 166c that retains the ID of a transfer source of data that is a target of the process, and a transfer destination server column 166d that retains the ID of a transfer destination of data generated by the process. These columns are associated with each other to be managed when each functional server performs a process.

For example, the first row represents “ETL 140 performs a data collecting process from the data source 150 that is the transfer source of data and outputs post-process data that is obtained through the collecting process to the DWH 130 that is the transfer destination.”.

The transfer destination server column 166d is set to “none” for the search server 120 or the analysis server 110. This represents that an index or metadata that is post-process data generated on the basis of data which is reflected on the DWH 130 is output to the AP server 180 (client side).

An example of the process schedule information 167 is schematically illustrated in FIG. 5. In the process schedule information 167, a server column 167a that retains the name of each functional server in the first system, a process column 167b that retains the name of a performance target process, a start time column 167c that retains the start time of the process, and an end time column 167d that retains the end time of the process are associated with each other to be managed.

The operation managing unit 161 instructs each functional server to perform a target process according to a schedule that is set in the process schedule information 167. A performance target server, the name of a performance target process, the start time, and the end time can be appropriately changed via an administrator terminal (not illustrated).

Returning to FIG. 2, the replication management server 300 will be described. The replication management server 300 obtains various pieces of information on the first system 100 and manages generation of the second system 200 that is a replication of the first system 100 on the basis of the process order, a process status, and a process schedule for each functional server.

The present embodiment uses an example in which the replication management server 300 is a physical computer that can communicate with the first system 100 and'the second system 200 through the network 10. However, the replication management server 300 may be realized as a part of any functional server in the first system or as a part of the operation management server 160.

A replication procedure managing unit 310 and a replication control unit 330 are realized through cooperation between a program and a CPU in the replication management server 300.

The replication procedure determining unit 310 obtains the server configuration information 165, the process information 166, and the process schedule 167 from the operation management server 160 of the first system 100 and generates a procedure for replicating each functional server of the first system 100 from these pieces of information. Specifically, a dependence relationship and the like between each functional server are analyzed from the obtained server configuration information 165 and the process information 166, and a directed graph table 168 indicating the dependence relationship and the like is generated. In the directed graph table 168, a transfer source and a transfer destination of data at the time of crawling are associated with the order of data transfer to be managed.

An example of the directed graph table 168 is schematically illustrated in FIG. 6. Items of a transfer source column 168a and a transfer destination column 168b of data are disposed in the directed graph table 168 and are associated with each other to be recorded. For example, the ETL, the DWH, the search server, the analysis server, and the operation management server are registered in the server configuration information 165 (FIG. 3). Next, the transfer source column 166c and the transfer destination server column 166d of the process information 166 (FIG. 4) are referred to for these functional servers, and these functional servers are registered in order in the transfer source column 168a and the transfer destination column 168b of the directed graph table 168. The operation management server does not have a transfer source and a transfer destination. In this case, the operation management server is not registered in the directed graph table 168.

FIG. 7 schematically illustrates a dependence relationship of data transfer between each functional server, the dependence relationship being deduced by creating the directed graph table 168. As illustrated in the same drawing, it can be understood that data is transferred first from the data source 150 to the ETL 140, transferred to the DWH 130 next, and thereafter is transferred to the analysis server 110 and the search server 120.

The replication procedure managing unit 310 performs a cycle identification process that checks whether a cycle is present or not on a data transfer path (order of data transfer between each functional server). A cycle is a data transfer path that has such a relationship that process data of a functional server performed in a functional server which is late in the order of data transfer in the computer system 1 is crawled by a functional server which is early in the order of transfer. For example, an analysis result is generated by the analysis server 110 performing a data analyzing process for data that is crawled from the DWH 130. Although an analysis result may be output to the group of clients 190 in response to a request for the analysis result, depending on the type of analysis, there may be provided a system configuration in which the analysis result is again crawled by the ETL 140.

The data transfer path in this case becomes a loop in a manner such as ETL→DWH→analysis server→ETL→DWH→analysis server . . . , and the integrity of data cannot be assured in the relationship of the analysis server with other functional servers (the search server here) that have a dependence relationship of data transfer with the analysis server in the computer system 1.

Therefore, the replication procedure managing unit 310 determines that a replication procedure for servers cannot be deduced when a cycle is detected through the cycle identification process and outputs to the management terminal (not illustrated) a reason that replication of a system with integrity assured in each functional server cannot be performed.

Next, the replication procedure managing unit 310 refers to the process schedule information 167 (FIG. 5), determines the order of replication and the time of replication of each functional server along the order of replication processes in the directed graph table 168, and generates a replication schedule table 170 (FIG. 8). Specifically, the order of replication processes is determined from the directed graph table 168 and the like and is registered in the replication schedule table 170. Then, the start time of replication of each functional server is computed from the time that is recorded in the end time column 167b of the process information 167. That is to say, the start time of replication of a functional server is computed from the time when data obtainment (crawling) from the functional server of a data obtainment destination among each functional server of the first system 100 is completed and is registered in a replication time column 170b.

FIG. 8 schematically illustrates an example of a replication order table 169 that is generated through a “server replication order deduction process”. In the replication order table 169, a server name column 169a and a replication process order column 169b are disposed, and the order of replication of each functional server that is computed through the server replication order deduction process is associated to be recorded.

FIG. 9 schematically illustrates an example of a replication time table 170 that is generated through a “replication process time deduction process”. In the replication time table 170, a server name column 170a and a replication time column 170c are disposed, and the start time of replication of each functional server that is computed by using the replication order table 169 and the process schedule information 167 is associated with the name of each functional server to be recorded.

Returning to FIG. 2, the replication control unit 330 performs the replication process for each functional server of the first system 100 on the basis of the replication time deduction process. The replication processes are sequentially started according to the times registered in the replication time table 170. Replication means obtaining an image of a functional server of the first system 100 as a snapshot and applying various methods such as reflection of the image on the second system 100.

Above is the configuration of the computer system 1.

Next, processing operation of the replication management server 300 will be described in detail by using the flowcharts illustrated in FIG. 10 to FIG. 17. Although each functional unit or the like is described as the main actor of processes in the following description, the present invention is not limited to these functional units. A part or all of the processes can be changed to an extent not departing from the intent of the processes.

FIG. 10 illustrates the outline of the entire operation of the replication management server 300.

In S101, the replication procedure managing unit 310 of the replication management server 300 transmits an obtainment request for the server configuration information 165, the process information 166, and the process schedule 167 to the operation management server 160 of the first system 100 and obtains the pieces of information.

In S103, the replication procedure managing unit 310 refers to the obtained server configuration information 165 and the process information 166, generates the directed graph table 168, and manages a dependence relationship that is related to data transfer between each functional server of the first system 100 (directed graph creating process in FIG. 11).

In S105, the replication procedure determining unit 310 generates a list of search starting servers and performs a process of determining a functional server that is the starting point of a series of data transfer occurring in the first system 100 by using the generated directed graph table 168 (search starting server determination process in FIG. 12).

In S107, the replication procedure managing unit 310 performs a process of determining whether a cycle is present or not by using the generated list of search starting servers (cycle identification process in FIG. 13 and FIG. 14).

In S109, when the replication procedure managing unit 310 determines that a cycle is present (YES in S109), the replication procedure determining part 310 proceeds to S117 and notifies the replication control unit 330 of a reason that the replication order cannot be deduced. When determining that a cycle is not present (NO in S109), the replication procedure managing unit 310 proceeds to S111.

In S111, the replication procedure managing unit 310 refers to the list of search starting servers, determines the order of replication of each functional server of the first system 100, associates the order with the name of corresponding servers, and registers the order in the replication schedule table 170 (replication order determination process in FIG. 15 and FIG. 16).

In S113, the replication procedure managing unit 310 determines the start time of the replication process for each functional server, associates the start time with the name of corresponding servers, and registers the start time in the replication time table 170 (replication start time determination process in FIG. 17).

Meanwhile, in S115, the replication procedure managing unit 310 notifies the replication control unit 330 of a reason that the replication order cannot be deduced on the basis of a determination in S109 that a cycle is present.

In S117, the replication control unit 330 measures the start time of replication registered in the replication time table 170 and replicates a corresponding functional server in the second system 200 when detecting the start time. When receiving notification of a reason that the replication order cannot be deduced in the process of S115, the replication control unit 310 notifies the management terminal and the like of the reason (system replication is performed without assuring data integrity by operation from a user).

Each process described above will be described in further detail.

FIG. 11 illustrates the flow of the “directed graph creating process”.

In S201, the replication procedure managing unit 310 refers to the process information table 166 from the first row and checks whether the name of a functional server is registered in the transfer source server column 166c of the referring row. The replication procedure managing unit 310 proceeds to S203 when the name of a functional server is registered (YES in S201) or proceeds to S209 when the name of a functional server is not registered (NO in S201).

In S203, the replication procedure managing unit 310 registers the “transfer source server name” that is registered in the transfer source server column 166c of the referring row and a “server name” that is registered in a server column 166a respectively in the transfer source column 168a and the transfer destination column 168b of the directed graph table 168.

In S205, the replication procedure managing unit 310 checks whether or not the name of a server is registered in the transfer destination server column 166d of the row that is referred to in S201. The replication procedure managing unit 310 proceeds to the process of S207 when the name of a server is registered (YES in S205) or proceeds to the process of S215 when the name of a server is not registered (NO in S205).

In S207, the replication procedure managing unit 310 registers a “server name” that is registered in the server column 166a of the referring row and a “transfer destination server name” that is registered in the transfer destination server column 166d respectively in the transfer source column 168a and the transfer destination column 168b of the next row in the directed graph table 168. Thereafter, the replication procedure managing unit 310 proceeds to the process of S215.

The flow of processes from S209 will be described here. In S209, the replication procedure managing unit 310 checks whether or not the name of a functional server is registered in the transfer destination server column 166d of the row that is referred to in S201. The replication procedure managing unit 310 proceeds to S211 when the name of a functional server is registered (YES in S209) or proceeds to the process of S213 when the name of a functional server is not registered (No in S209).

In S211, the replication procedure managing unit 310 registers the “transfer destination server name” that is registered in the transfer destination server column 166d of the referring row and a “server name” that is registered in the server column 166a respectively to the transfer source column 168a and the transfer destination column 168b of the directed graph table 168. Thereafter, the replication procedure managing unit 310 proceeds to the process of S215.

Meanwhile, in S213, when it is determined that a “transfer destination server name” is not registered in the transfer destination server column 166d of the referring row, a server that is recorded in the server column 166a of the referring row is not registered in the directed graph table 168, and information on the server is managed (recorded) separately from the directed graph table 168 as “arbitrarily replicable”. That is to say, in the process information table 166, a functional server that is not registered to any of the transfer source server column 166c and the transfer destination server column 166d is a functional server that does not have a direct relevance in data transfer, and a replication of the functional server can be created at an arbitrary timing in the second system 200. After managing the functional server separately, the replication procedure managing unit 310 proceeds to the process of S215.

In S215, the replication procedure managing unit 310 checks whether there is a non-referred row in the process information table 166. The replication procedure managing unit 310 returns to S201 and repeats the processes when there is a non-referred row (YES in S215) or ends the process when there is not a non-referred row (NO in S215). Above is the “directed graph creating process”.

FIG. 12 illustrates the flow of the “search starting server determination process”. The present process is a process of generating the list of search starting servers (not illustrated) by using the directed graph table 168 that is created through the above “directed graph table creating process” and determining a functional server that is the starting point of data transfer by using the list of search starting servers.

In S301, the replication procedure managing unit 310 refers to the directed graph table 168 from the first row one by one and extracts a “server name” from a “server name” group that is registered in the transfer source column 168a.

In S303, the replication procedure managing unit 310 determines whether the extracted “server name” of the transfer source column is already registered in the list of search starting servers. The replication procedure managing unit 310 proceeds to S307 when the extracted “server name” is already registered (Yes in S303) or proceeds to S305 and registers the “server name” of the transfer source column in the list of search starting servers when the extracted “server name” is not registered (No in S303).

In S307, the replication procedure managing unit 310 checks whether or not there is a non-extracted row in the directed graph table 168. The replication procedure managing unit 310 returns to S301 and repeats the processes when there is a non-extracted row (YES in S307) or proceeds to S309 when there is not a non-extracted row (NO in S307).

In S309, this time, the replication procedure managing unit 310 extracts a “server name” registered in the transfer destination column 168b of the directed graph table 168 from the first row one by one.

In S311, the replication procedure managing unit 310 determines whether or not there is a “server name” that matches the “server name” of the transfer destination column 168b, which is extracted in S309, in the “server name” group of the transfer source column 168a which is registered in the list of search starting servers through S301 to S307. The replication procedure managing unit 310 proceeds to S313 when there is a matching “server name” (YES in S311) or proceeds to S315 when there is not a matching “server name” (NO in S311).

In S313, the replication procedure managing unit 310 excludes (for example, registers as null) the “server name” of the transfer source column that matches the “server name” of the transfer destination column from the list of search starting servers.

In S315, the replication procedure managing unit 310 determines whether or not there is a non-referred row in the directed graph table 168. The replication procedure managing unit 310 returns to S309 and repeats the processes when there is a non-referred row (YES in S315) or ends the present process when there is not a non-referred row (YES in S315). Above is the “search starting server determination process”.

In the example of the directed graph table 168 illustrated in FIG. 6, for example, four names of transfer source servers, “data source”, “ETL”, “DWH”, and “DWH”, are registered in the transfer source column 168a, and three of “data source”, “ETL”, and “DWH” are registered in the list of search starting servers (only one “DWH” is registered since duplicated”). Among these, “ETL” and “DWH” match the name of servers registered in the transfer destination column 168b. “data source” remains when these are excluded. As such, the search starting server determination process can determine that “data source” is the server that is the starting point of data transfer in the first system 100.

FIG. 13 illustrates the flow of “cycle identification process”. The present process is a process of identifying whether a cycle is present or not by using the content that is registered in the list of search starting servers.

The present flowchart is a recursive function with a server as an argument, and the function in the flow performs the same flow again with a new server as an argument. A stack is used as an area storing a server and can be referred to by all cycle detecting functions. The stack is used in the operation of storing a server for each calling of a cycle detecting function and deleting the server when the process of the function ends. By preparing such a stack, the stack can be referred to while performing a depth-first search by using a recursive function, and whether a server that is already registered in the stack is referred to again can be identified. A case where a server is referred to again means a loop structure, and thus the cycle detecting function outputs the fact that a cycle is detected.

In S401, the replication procedure managing unit 310 obtains the list of search starting servers and reads the name of a server registered in the first row.

In S403, the replication procedure managing unit 310 reads one server (in the first row here) that is extracted in S401 and obtains presence or absence of a cycle by using the cycle detecting function (“cycle detecting function process”). Specifically, with the server as an argument, the replication procedure managing unit 310 checks whether the server as an argument is present in the stack in which searched servers are recorded. This will be described in detail later.

In S405, the replication procedure managing unit 310 determines whether a cycle is present. The replication procedure managing unit 310 proceeds to the process of S411 when determining that a cycle is present (YES in S405) and retains recording of “cycle present” or proceeds to the process of S407 when determining that a cycle is not present (NO in S405).

In S407, the replication procedure managing unit 310 determines whether there is a non-referred row in the list of search starting servers. The replication procedure managing unit 310 returns to S401 and repeats the processes for a non-referred row when there is a non-referred row (YES in S407) or proceeds to S409 when there is not a non-referred row (NO in S407). In S409, the replication procedure managing unit 310 retains recording of “cycle not present”.

FIG. 14 illustrates the flow of above-described “cycle detecting function process” in detail. This flow is a recursive function that is used in the flowchart of cycle presence identification. The present function uses a server as an argument.

In S421, the replication procedure managing unit 310 checks with the recursive function whether a server of an argument is present in the stack in which searched servers are recorded. The replication procedure managing unit 310 proceeds to S439 when the server of an argument is present in the stack (YES in S421) and outputs “cycle detected” as a return value of the function. The replication procedure managing unit 310 proceeds to S423 when the server of an argument is not present in the stack (NO in S421).

In S423, the replication procedure managing unit 310 adds the server of an argument of the function to the stack.

In S425, the replication procedure managing unit 310 refers to the directed graph table by one row and extracts the name of a server of the transfer source column 168a.

In S427, the replication procedure managing unit 310 determines whether or not the extracted name of a server and the name of the server of an argument are the same. The replication procedure managing unit 310 proceeds to S429 when the extracted name of a server and the name of the server of an argument are the same (YES in S427). The replication procedure managing unit 310 proceeds to S433 when the extracted name of a server and the name of the server of an argument are not the same (NO in S427).

In S429, the replication procedure managing unit 310 executes the cycle detecting function with the name of a server registered in the transfer source column 168b of the referring row of the directed graph table 168 in S425 as an argument.

In S431, the replication procedure managing unit 310 determines whether a cycle is detected. The replication procedure managing unit 310 proceeds to S439 when a cycle is detected (YES in S431) and outputs “cycle detected” as a return value of the function. The replication procedure managing unit 310 proceeds to S433 when a cycle is not detected (NO in S431).

In S433, the replication procedure managing unit 310 checks whether or not there is a non-referred row in the directed graph table 168. The replication procedure managing unit 310 returns to S425 and repeats the processes when there is a non-referred row (YES in S433). The replication procedure managing unit 310 proceeds to S435 and deletes the server of an argument from the stack when there is not a non-referred row (NO in S433).

In S437, thereafter, the replication procedure managing unit 310 outputs “cycle not present” as a return value of the function.

FIG. 15 illustrates the flow of the replication order determination process. The present process uses a topological sort to sequence servers in order of dependence relationship of data transfer. That is to say, a server numbering function performs a depth-first search and performs numbering sequentially when each function ends.

In S501, the replication procedure managing unit 310 initializes a variable i to 0 (zero). The variable i is a variable that can be referred to by all of the relevant server numbering.

In S503, the replication procedure managing unit 310 obtains the list of search starting servers.

In S505, the replication procedure managing unit 310 refers to a record of the obtained list of search starting servers by one row (the first row here).

In S507, the replication procedure managing unit 310 performs a server numbering function process with a server in the referring row as an argument. This will be described in detail later.

In S509, the replication procedure managing unit 310 determines whether there is a non-referred row or not. The replication procedure managing unit 310 returns to S505 and repeats the processes when there is a non-referred row (YES in S509) or ends the process when there is not a non-referred row (NO in S509).

FIG. 16 illustrates the flow of the server numbering function process. The present function uses a server as an argument.

In S521, the replication procedure managing unit 310 performs a process of adding a server of an argument to a list of traversed servers. The list of traversed servers can be referred to by all of the server numbering functions.

In S523, the replication procedure managing unit 310 refers to the directed graph table 168 by one row and extracts the name of a server in the transfer source column 168a and the name of a server in the transfer destination column 168b.

In S525, the replication procedure managing unit 310 checks whether two conditions of “the extracted name of a server in the transfer source column 168a and the name of the server of an argument are the same” and “the name of a server in the transfer destination column 168b of the row is not registered in the list of traversed servers” are satisfied or not. The replication procedure managing unit 310 proceeds to S527 when the two conditions are satisfied (YES in S525) or proceeds to S529 when the two conditions are not satisfied (NO in S525).

In S527, the replication procedure managing unit 310 executes the server numbering function with the name of a server in the transfer destination column 168b of the row as an argument.

In S529, the replication procedure managing unit 310 checks whether or not there is a non-referred row in the directed graph table 168. The replication procedure managing unit 310 returns to S523 and repeats the processes when there is a non-referred row (YES in S529). The replication procedure managing unit 310 proceeds to S531 when there is not a non-referred row (NO in S529).

In S531, the replication procedure managing unit 310 adds one to the variable i and in S533, outputs the variable i as the number of the server of an argument.

The replication order table 169 (FIG. 8) is generated through above “cycle identification process” and “server numbering process”, and the replication order of each functional server is determined.

The replication order table (FIG. 8) is created through the above processes in FIG. 15 and FIG. 16.

FIG. 17 illustrates the flow of a replication start time computing process. The present process is a process of computing the replication time of each server and uses the replication order table 169 and the process schedule table 167 to compute the start time of replication. A server that is present in the replication order table 169 and is not present in the process schedule information 167 is replicated at the same time as the server that is replicated before the above server according to the replication order table 167.

In S601, the replication procedure managing unit 310 obtains the replication order table 169 and in S603, obtains the process schedule table 167. The replication procedure managing unit 310 refers to the obtained replication order table 169 by one row.

In S607, the replication procedure managing unit 310 checks whether or not “server name” of the referring row in the replication order table 169 is present in the process schedule information 167. The replication procedure managing unit 310 proceeds to S609 when the name of a server of the referring row is present in the process schedule information 167 (YES in S607) or proceeds to S613 when the name of a server of the referring row is not present in the process schedule information 167 (NO in S607).

In S609, the replication procedure managing unit 310 computes the start time of replication of the server on the basis of the end time (means the time processing of the functional server ends) of the name of the corresponding server in the process schedule information 167. The start time of replication may be the time processing of the functional server ends or may be a time after a predetermined time (for example, after a few minutes) from the time processing of the functional server ends.

In S611, the replication procedure managing unit 310 further stores the end time of the name of the corresponding server in the process schedule information 167 as a variable X.

Meanwhile, in S613, the replication procedure managing unit 310 outputs the time in the variable X as the start time of replication of the server.

In S615, the replication procedure managing unit 310 checks whether there is a non-referred row in the replication order table 169. The replication procedure managing unit 310 returns to S605 and repeats the processes when there is a non-referred row (YES in S615) or ends the process when there is not a non-referred row (NO in S615).

The replication time table 170 (FIG. 9) is generated through these processes, and the start time of replication of each functional server can be deduced. Thereafter, the replication control unit 330 replicates each functional server of the first system 100 in the second system 200 on the basis of the start time of replication that is deduced by the replication procedure managing unit 310.

As described above, according to the computer system 1 in the present embodiment, there can be generated a replicated system in which data integrity is secured in a group of functional servers that are in a data transfer relationship. Accordingly, the effect of early start of operation is achieved by using a system that is configured by each replicated functional server.

In addition, according to the computer system 1 in the present embodiment, a cycle that is present on the data transfer path between functional servers can be detected. Data integrity between functional servers can be further assured. Furthermore, when there is a cycle, the reason that the replication order cannot be deduced is reported, and a normal replication process can be performed.

### Second Embodiment

The first embodiment generates a replicated system (second system 200) in which data integrity is assured between each functional server constituting the first system 100. In a second embodiment, a description will be provided for a computer system in which a specific functional server is replicated in the second system along the start time of replication in the replication time table 170 (FIG. 9), and then the operation of the replicated server is tested until a replication of another subsequent functional server is generated.

In a case of generating a replicated system of a computer system that is configured by a plurality of functional servers, a replicated system is either actually operated or tested after replications of more than two or all of the functional servers are configured. As a result, when a fault is caused, specifying a functional server that is the cause of the fault is complicated.

As a cause of a fault, for example, there may be caused a fault that a new data format cannot be searched in the search server when a new data source of a new data format is added to the system that is operated. It is considered due to such a fault that the ETL does not correctly respond to a protocol for obtaining data from a new data source, the DWH does not respond to storing of a new data format, and the search server cannot extract text data of a search target from data in a new data format.

Therefore, performing a test when a replication of a functional server that is a part constituting a replicated system is generated has the advantage of facilitating characterization of a server that is the cause of a fault. Hereinafter, the computer system in the second embodiment will be described.

In the computer system in the second embodiment, the replication management server 300 includes a partial testing unit (not illustrated) that controls partial testing of a functional server. The partial testing unit receives specification of a functional server for which a user desires to perform an operation test via the management terminal and the like (not illustrated). Furthermore, the partial testing unit reports to a user the fact that a functional server can be tested via the management terminal and the like when the functional server is a server of a testing target after the functional server is replicated in the .second system 200, and the partial testing unit receives input of the fact that testing of the functional server is completed from a user. The replication management server 300 temporarily stops the subsequent replication process for the functional servers until receiving input of test completion from a user. Other configurations include the same configurations as the computer system in the first embodiment.

FIG. 18 illustrates the process flow of the computer system in the second embodiment.

In S701, the partial testing unit obtains the replication order table 169 (FIG. 8) and the replication time table 170 (FIG. 9) that are deduced by the replication procedure managing unit 310.

In S703, the partial testing unit receives specification of a server of a partial testing target from a user and stores the server.

In S705, the partial testing unit refers to the replication order table 169 by one row (the first row here).

In S707, the partial testing unit refers to the replication time table 170 and waits until the start time of replication of the name of a server in the read row.

In S709, the partial testing unit notifies the replication control unit of an instruction to replicate a server having the name of a server when the current time becomes the start time of replication.

In S711, the partial testing unit determines whether or not the server for which the instruction to replicate is notified is the server of a testing target that is received in S703. The partial testing unit proceeds to S713 when the server is the server of a testing target (YES in S711) or proceeds to S717 when the server is not the server of a testing target (NO in S711).

In S713, the partial testing unit notifies the management terminal of the fact that the server of a testing target is in a testable state. A user performs testing of the replicated server in response to the notification.

In S715, the partial testing unit waits until receiving a notification of the fact that testing of the server of a testing target is ended from the management terminal.

In S717, the partial testing unit checks whether there is a non-referred row in the replication order table 169 after receiving a notification of the end of the test. The partial testing unit returns to S705 and repeats the processes when there is a non-referred row or ends the process when there is not a non-referred row.

Above is the description of the computer system in the second embodiment.

According to the computer system in the second embodiment, each functional server can be tested at the timing of being replicated, and the effect of facilitating specification of the place of a fault can be achieved.

The embodiments of the present invention are described hereinbefore, but the present invention is not limited to these examples. It is needless to say that various configurations or operation can be applied to the present invention to an extent not changing the gist of the invention.

For example, a method of making an image of a replication source as a snapshot is applied in replication of a functional server, but a method of replicating data in both a main storage area and an auxiliary storage area of a functional server (a snapshot creating function and the like of a virtual machine) or a method of replicating data in an auxiliary storage area only (writable snapshot function and the like) can be applied in the replication method.

In addition, an example of each functional unit in the embodiments is described as being realized through cooperation between a program and a CPU, but a part or all of the functional units can also be realized as hardware.

It is needless to say that the program for realizing each functional unit in the embodiments can be stored on an electric, electronic and/or magnetic non-temporary recording medium.

### REFERENCE SIGNS LIST

100 first system, 110 analysis server, 120 search server, 130 DWH, 140 ETL, 150 data source, 168 directed graph table, 169 replication order table, 170 replication time table, 200 second system, 310 replication procedure managing unit, 330 replication control unit

1. A management device that manages a computer system including a second subsystem which performs a predetermined process for data processed by a first subsystem and generates data which is a target of data processing by a third subsystem,
wherein the management device obtains process history information in which information indicating an input source subsystem and an output destination subsystem of data that is processed by each of the first, the second, and the third subsystems is included and trigger information in which information indicating a trigger for data input and output of the input source and the output destination subsystems is included,
detects a dependence relationship of data input and output between the first, the second, and the third subsystems from the process history information,
calculates, on the basis of the dependence relationship, a replication trigger for subsystems subsequent to a next subsystem for each of the subsystems subsequent to the next subsystem that is next to a subsystem of which an input source is not present with reference to the trigger information, and
generates, in response to the replication trigger, a replication of each of the subsystems subsequent to the next subsystem in another computer system that is different from the computer system.

2. The management device according to claim 1,
wherein the management device determines by using the dependence relationship whether a subsystem that is in a relationship in which the data input source is a data output destination of another subsystem among the first, the second, and the third subsystems, and
does not calculate the replication trigger when a subsystem that is in a relationship in which the data input source is a data output destination of another subsystem is present in the determination result.

3. The management device according to claim 2,
wherein the management device outputs the fact that a subsystem that is in a relationship in which the data input source is a data output destination of another subsystem is present in the determination result.

4. The management device according to claim 1,
wherein the management device has the trigger information and a trigger in the replication trigger as a time.

5. The management device according to claim 1,
wherein when generating a replication of each of the subsystems subsequent to the next subsystem in response to the replication trigger,
the management device outputs, before replication of a subsystem, the fact that the subsystem is in a state where replication can be started, and
waits for the replication until an instruction to start replication is present.

6. A method for managing a computer system including a second subsystem which performs a predetermined process for data processed by a first subsystem and generates data which is a target of data processing by a third subsystem,
wherein a managing unit of the computer system
obtains process history information in which information indicating an input source subsystem and an output destination subsystem of data that is processed by each of the first, the second, and the third subsystems is included and trigger information in which information indicating a trigger for data input and output of the input source and the output destination subsystems is included,
detects a dependence relationship of data input and output between the first, the second, and the third subsystems from the process history information,
calculates, on the basis of the dependence relationship, a replication trigger for subsystems subsequent to a next subsystem for each of the subsystems subsequent to the next subsystem that is next to a subsystem of which an input source is not present with reference to the trigger information, and
generates, in response to the replication trigger, a replication of each of the subsystems subsequent to the next subsystem in another computer system that is different from the computer system.

7. A computer-readable non-temporary recording medium that stores a program allowing a computer which manages a computer system including a second subsystem which performs a predetermined process for data processed by a first subsystem and generates data which is a target of data processing by a third subsystem to perform
a step of obtaining process history information in which information indicating an input source subsystem and an output destination subsystem of data that is processed by each of the first, the second, and the third subsystems is included and trigger information in which information indicating a trigger for data input and output of the input source and the output destination subsystems is included,
a step of detecting a dependence relationship of data input and output between the first, the second, and the third subsystems from the process history information,
a step of calculating, on the basis of the dependence relationship, a replication trigger for subsystems subsequent to a next subsystem for each of the subsystems subsequent to the next subsystem that is next to a. subsystem of which an input source is not present with reference to the trigger information, and
a step of generating, in response to the replication trigger, a replication of each of the subsystems subsequent to the next subsystem in another computer system that is different from the computer system.
